(19) United States
(12) Patent Application Publication
(10) Pub. No.: US 2025/0314387 A1
(43) Pub. Date: Oct. 9, 2025

(54) SOLAR THERMAL ENERGY COLLECTION AND STORAGE FOR HEATING BUILDINGS

(71) Applicant: HOLLICK SOLAR SYSTEMS LIMITED, King City (CA)

(72) Inventor: John C. HOLLICK, Toronto (CA)

(21) Appl. No.: 18/733,341

(22) Filed: Jun. 4, 2024

Related U.S. Application Data
(60) Provisional application No. 63/631,235, filed on Apr. 8, 2024.

(51) Int. Cl. F24D 11/02; F24D 11/00; F24F 12/00; F24H 4/02; F24S 20/66; F24S 50/40; F24S 60/10

(52) U.S. Cl. CPC F24D 11/0221; F24D 11/003; F24F 12/003; F24H 4/02; F24S 20/66; F24S 50/40; F24S 60/10

(57) ABSTRACT

An apparatus for heating ambient air for an ASHP, the apparatus including a thermal battery and a sunlight-absorbent collector panel configured to be mounted on a building. The panel is exposed to ambient air and defines an air collection space between itself and the building when mounted on the building. The collector panel has a plurality of air inlet openings to allow the ambient air to flow into the air collection space. A panel outlet allows the collected air to flow from the air collection space to the thermal battery. The thermal battery includes battery airflow outlet in fluid communication with the ASHP and an external vent to the outside. One or more dampers control the airflow through the external vent and/or the battery airflow outlet. An air mover maintains a predefined airflow from the panel outlet to the battery airflow inlet. A controller controls the position of the one or more dampers.

This application claims priority to U.S. Provisional Patent Application No. 63/631,235 titled “THERMAL BATTERY”, filed on Apr. 8, 2024. The specification relates generally to heating buildings, and specifically to solar thermal energy collection and storage for heating buildings.

### BACKGROUND

Many existing buildings and particularly apartment buildings are heated with natural gas boilers that produce hot water or steam which is circulated through the building with pipes. The path to achieving carbon neutrality and to transition away from using natural gas as energy source in buildings can be challenging, as replacing existing heating infrastructure in the buildings can be a difficult and costly endeavor. Building owners are encouraged to introduce Air Source Heat Pumps (ASHPs) or Ground Source Heat Pumps (GSHPs) into their buildings heating systems; however, introducing an ASHP, a GSHP, or a combination of ASHPs and GSHPs into a building is not always economically and/or physically viable. ASHPs may be economically viable when ambient air temperature is above freezing but their performance drops as ambient air temperature drops. For example, their Coefficient of Performance (COP) value can drop to about 1, which is a similar COP value at which electric resistance heating systems typically operate. At such a low COP value ASHPs are not an economical alternative to commercially available electric resistance heating systems and can impose a high demand on the electrical grid. GSHPs require large ground volumes to accommodate the necessary piping to install a GSHP. Such large ground volumes are not typically available to most urban buildings.

Canadian Patent No. 1,326,619, issued Feb. 1, 1994 and U.S. Pat. Nos. 4,899,728 and 4,934,338, issued Feb. 13, 1990 and Jun. 19, 1990, respectively, disclose the use of an unglazed solar panel to heat fresh make-up air prior to its introduction into a building. These systems can be very efficient when heating large airflow rates per surface area of solar panel, for example at approximately 6 cubic feet per minute per square foot. However, this efficiency drops dramatically when lower air flow rates are used. Using low flow rates results in higher temperatures on the solar panel, leading to increased radiation heat loss to ambient. These systems also suffer other disadvantages. For example, the maximum temperature rise that can be realized is about 30° C. above ambient temperature for low flow designs. Many ASHPs require air input at a temperature of approximately 10° C. Thus, a temperature rise of about 30° C. is insufficient for heating buildings in cold climates which, for example, can reach temperatures of about-40° C. Also, their efficiency is reduced on windy days as the wind can blow significant amounts of heat away from the panels around their air inlets if the velocity of the air entering the panels is not high enough.

Additionally, commercially available solar thermal liquid collectors are not economically viable for space heating, only operate on sunny days, are subject to freezing issues in winter, can result in high maintenance costs and reliability issues when wall- mounted, and can cause overheating problems in summer when space heating is not required. Furthermore, as discussed above, ASHPs do not perform well in subzero temperatures and have high maintenance requirements when operating at low temperatures.

Accordingly, it is desirable to obviate or mitigate the above-mentioned disadvantages.

### SUMMARY

In accordance with an aspect of an embodiment, there is provided an apparatus for outputting heated air when mounted to a building, the apparatus comprising: at least one sunlight-absorbent collector panel configured to heat air passing proximal thereto, the panel shaped to create an enclosed air collection space when mounted to the building, the panel comprising: a plurality of inlet openings; and a panel outlet; a thermal battery comprising: thermal material; a battery airflow inlet; an external vent configured to interface with the ambient air outside the battery; a battery airflow outlet configured to be in fluid communication with an air-source heat pump (ASHP); one or more dampers configured to control the airflow rate through the external vent and/or the battery airflow outlet; an air mover configured to maintain a predefined airflow from the panel outlet to the battery airflow inlet; and a controller configured to control the position of the one or more dampers. In some embodiments, the ASHP is for use in heating the building. In some embodiments, the ASHP is for use in heating water.

A plurality of sensors may be configured to detect a temperature of airflow from the battery airflow outlet and/or an airflow speed from the panel outlet; wherein the controller is configured to control the position of the one or more dampers in response to the detected temperature and/or airflow speed.

A duct may be configured to couple the panel outlet with the battery airflow inlet. The air mover may be an inline fan positioned with the duct and/or a fan positioned within the thermal battery. The inlet openings in the panel may be located along a surface of the panel. The air collection space may be configured to collect exhaust from exhaust vents in the building when the panel is coupled to the building. The battery airflow outlet may comprise an opening configured to couple the thermal battery to a mechanical penthouse room of the building.

The thermal material may be a phase change material (PCM) having a melting point configured to provide a predefined air temperature for the ASHP. The predefined air temperature may be in the range of 5° C. to 15° C.

In accordance with another aspect of an embodiment, there is provided a system for heating a building the system comprising: at least one sunlight-absorbent collector panel coupled to the building, the panel configured to heat air passing proximal thereto, the panel shaped to create an enclosed air collection space between the building and the panel, the panel comprising: a plurality of inlet openings; and a panel outlet; a thermal battery comprising: thermal material; a battery airflow inlet; an external vent configured to interface with the ambient air outside the battery; a battery airflow outlet; one or more dampers configured to control the airflow rate through the external vent and/or the battery airflow outlet; an air mover configured to maintain a predefined airflow from the panel outlet to the battery airflow inlet; a controller configured to control the position of the one or more dampers; and an air-source heat pump (ASHP) in fluid communication with the battery airflow outlet, the ASHP configured to collect heat the air received from the thermal battery and transfer the collected heat to hot water. In some embodiments, the ASHP is for use in heating the building. In some embodiments, the ASHP is for use in heating water.

A plurality of sensors may be configured to detect a temperature of airflow from the battery airflow outlet and/or an airflow speed from the panel outlet; wherein the controller is configured to control the position of the one or more dampers in response to the detected temperature and/or airflow speed.

A duct may be configured to couple the panel outlet with the battery airflow inlet. The air mover may be an inline fan positioned with the duct. The inlet openings in the panel may be located along a surface of the panel. The panel may be coupled to the building adjacent exhaust vents in the building so that the exhaust vents exhaust into the air collection space.

The thermal material may be a phase change material (PCM) having a melting point configured to provide a predefined air temperature for the ASHP.

A second-stage water heat pump may be configured to boost a temperature of the hot water from the ASHP to one of a higher water temperature and a steam temperature for use in heating the building.

The battery airflow outlet may comprise an opening configured to couple the thermal battery to a mechanical penthouse room of the building.

In accordance with another aspect of an embodiment, there is provided a method for controlling airflow at a thermal battery, the thermal battery including a battery airflow inlet, an external vent, and a battery airflow outlet, the method including: using sensors to measure an input airflow at the battery airflow inlet, the input airflow heated by at least one sunlight-absorbent collector panel; using sensors to measure an output airflow at the battery airflow outlet for output to an ASHP; and controlling a damper in the external vent to balance the input airflow and the output airflow.

When the input airflow is greater than the output airflow, the damper may be controlled to allow excess airflow from input airflow exhaust to the outside. When the input airflow is less than the output airflow, the damper may be controlled to allow air to be drawn in from the outside to combine with the input airflow.

In accordance with another aspect an apparatus for heating ambient air for an ASHP is provided. The apparatus includes a thermal battery and a sunlight-absorbent collector panel configured to be mounted on a building. The panel is exposed to ambient air and defines an air collection space between itself and the building when mounted on the building. The sunlight-absorbent collector panel has a plurality of air inlet openings to allow the ambient air to flow through the openings into the air collection space. A first air outlet is provided in the panel for the collected air to flow from the air collection space to the thermal battery. At least a damper is provided in the thermal battery to allow the collected air to escape from the thermal battery based on a hot air requirement from the ASHP. A second air outlet is provided in the thermal battery for hot air to flow from the thermal battery to an air side of the ASHP.

In some embodiments, the panel encloses exhaust vents from the building so that exhaust flowing from an interior of the building through the exhaust vents exits into the air collections space.

In some embodiments, the apparatus includes a heat pump fan in fluid communication with the thermal battery for directing heated air through an evaporator of the ASHP. The ASHP may thereby collect heat from the heated air and transfer the collected heat to hot water for use in the building.

In some embodiments, the apparatus includes a second-stage water heat pump. The apparatus is further configured to store the hot water in a liquid thermal storage tank. The second-stage water heat pump is configured to boost a temperature of the stored hot water to one of a higher water temperature and a steam temperature for use in the building.

### BRIEF DESCRIPTIONS OF THE DRAWINGS

Embodiments are described by way of example only with reference to the following figures in which:

FIG. 1 is a schematic drawing of an embodiment of solar thermal collection and storage apparatus installed on a building.

FIG. 2 is a schematic drawing of an alternative view of the solar thermal collection and storage apparatus.

FIG. 3 is a schematic drawing of yet an alternative view of the solar thermal collection and storage apparatus.

FIG. 4 is a schematic drawing of an alternative embodiment of the solar thermal collection and storage apparatus.

FIG. 5 is an elevation schematic drawing of an alternative view of the solar thermal collection and storage apparatus illustrated in FIG. 4.

FIG. 6 is a block diagram illustrating an example of a method for operating the the solar thermal collection and storage apparatus.

### DETAILED DESCRIPTION

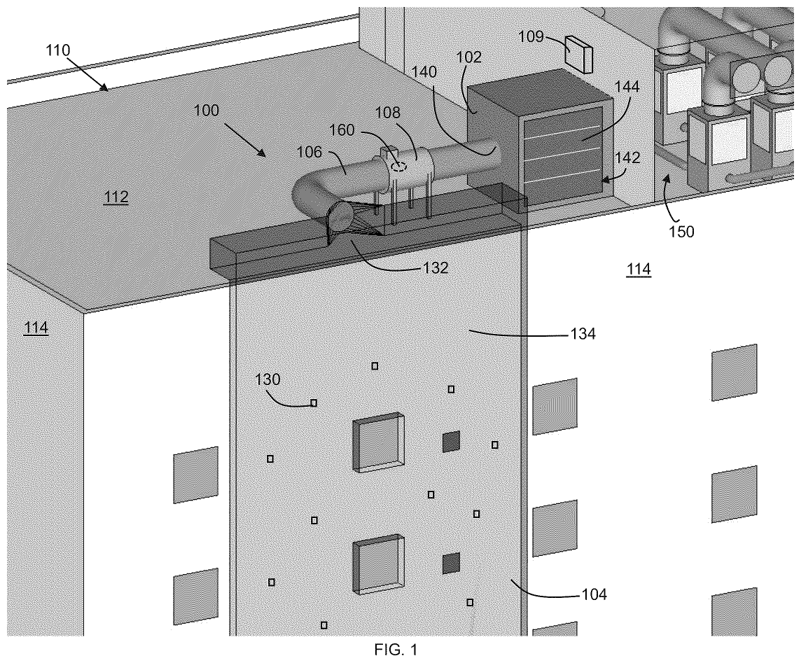

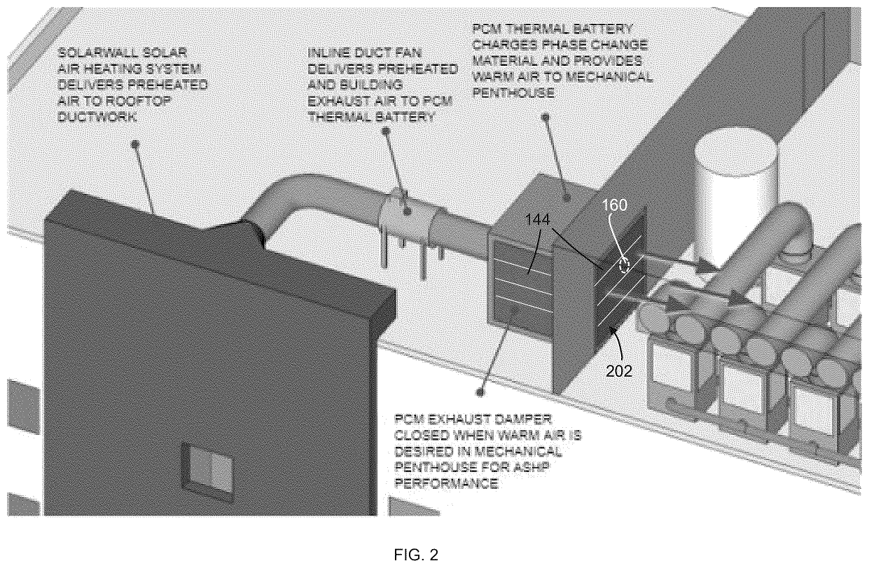

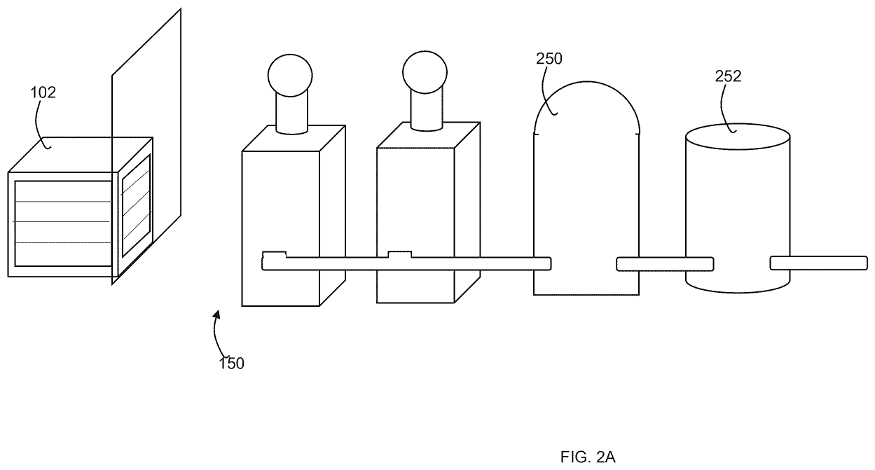

For convenience, like numeral in the description refer to like structures in the drawing. Referring to FIGS. 1 and 2, a schematic drawing illustrating an example apparatus for heating ambient air is shown generally by numeral 100. The apparatus 100 includes a thermal battery 102, a sunlight-absorbent collector panel 104, a duct 106, an inline duct fan 108, and a controller 109. The heated ambient air is to be used as a source for an air supply heat pump (ASHP) 150.

In some embodiments, the apparatus 100 is mounted to a building 110 having a flat roof 112 and a plurality of walls 114. The panel 104 is mounted to the building 110 so that it is positioned along at least one if its walls 114. In some embodiments, the panel 104 extends from the roof 112 downward alongside the at least one wall 114. The panel 104 is preferably mounted so that it is positioned along one or more walls 114 that receive maximal sunlight. For example, in some embodiments, the panel 104 may be mounted so that it is positioned at least along a south-facing wall 114 if the building 110 is located in the northern hemisphere. Similarly, in some embodiments, the panel 104 may be mounted so that it is positioned along at least a north-facing wall 114 if the building 110 is located in the southern hemisphere. However, the panel 104 may be mounted so that it is positioned along any suitable wall 114 of the building 110 depending on factors such as available sunlight, shading, energy demand patterns, and local climate conditions. In some embodiments, the panel 104 is shaped so that when it is mounted to the building 110, it is positioned along two adjacent walls 114. Yet further, in some embodiments multiple panels 104 may be used. The multiple panels 104 may be mounted so that each of the panels 104 is positioned along the same or different walls 114.

The panel 104 includes a plurality of inlet openings 130 and a panel outlet 132. In some embodiments, the inlet openings 130 are positioned about the surface of the panel 104. The panel outlet 132 is positioned proximal the top of the panel 104. The panel 104 is shaped so that when it is mounted to the building 110, an enclosed air collection space 134 is defined therebetween. In some embodiments, the panel 104 is mounted to the building adjacent exhaust vents 116 in the wall 114 so that the exhaust vents 116 exhaust into the air collection space 134. The exhaust vents 116 may be vents from the kitchens and/or bathrooms, for example. The exhaust may be combined with the ambient air in the air collection space 134 since the combination is not recycled back into the building 110. Rather, it is used as input to the ASHP as will be described. Accordingly, the location of exhaust vents may also be a determining factor in the placement of the panel 104.

The panel 104 is configured to be coupled to the thermal battery 102. In some embodiments, the panel outlet 132 is configured to be coupled to a first end of the duct 106. The inline duct fan 108 is configured to maintain a predefined airflow through the duct 106. As previously noted, the panel can be very efficient when heating large airflow rates per surface area of solar panel. Thus, the predefined airflow is selected to maintain the efficiency of the panel 104. A second, opposing end of the duct 106 is configured to be coupled to the thermal battery 102.

The thermal battery 102 includes a thermal storage material, a battery airflow inlet 140, an external vent 142, and a battery airflow outlet 202. As is known in the art, the thermal storage material may include sensible thermal storage material and/or latent thermal storage material. Sensible thermal storage material preserves its condition as a solid or a liquid. Examples include rocks, gravel, and concrete blocks. Latent thermal storage depends on a change of the material from solid to liquid and vice versa. Examples include Phase Change Materials (PCMs), which can consist of organic or inorganic materials. The PCMs can be designed with a melting point at temperature sufficient to provide the desirable airflow temperature to the ASHP 150. For example, in some embodiments, the melting point is in the range of 5° C. to 15° C.

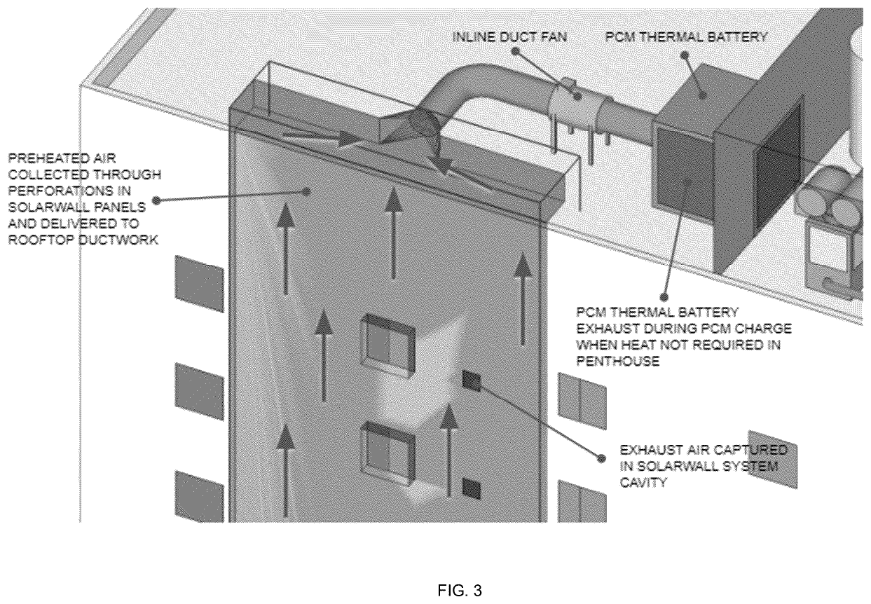

The battery airflow inlet 140 is configured to be coupled to the second end of the duct 106. The battery airflow outlet 202 is configured to be coupled to the ASHP 150. In some embodiments, the battery airflow outlet 202 includes a damper 144 configured to regulate airflow to the ASHP. The battery airflow outlet 202 may further include a grill, mesh or filter. In some embodiments, the battery airflow outlet 202 is an opening coupling the thermal battery 102 to a mechanical penthouse room of the building 110 where the ASHP may be located, as illustrated in FIG. 1 to FIG. 3. The external vent 142 vent includes a damper 144 configured to regulate airflow into and out of the thermal battery 102 from the outside. The external vent 142 may further include a grill, mesh or filter. The dampers 144 may be open, partially open, or closed.

The controller 109 includes at least a processor communicatively connected to a memory. The processor may be implemented as a plurality of processors or one or more multi-core processors. The processor may include one or more of a Central Processing Unit (CPU), a microcontroller, a microprocessor, a processing core, a Field-Programmable Gate Array (FPGA) or the like, and combinations thereof. The processor can be part of a building automation system, for example, a distributed control system comprising at least one Programmable Logic Controller (PLC). Alternatively, the processor can be a stand-alone component. As a stand-alone component, the controller 109 can be provided at various locations including, for example, within the thermal battery 102.

The controller 109 is configured to communicate with one or more sensors 160, including, for example, a temperature sensor at the ASHP and one or more air flow sensors at the inline duct fan 108. For example, some ASHPs may vary the fan speed based on the air temperature. A higher air volume, or air fan speed, may be required when the air is colder. Conversely, a lower air volume, or air fan speed, may be required when the air is warmer to achieve the same amount of heat output. The controller 109 can increase or decrease the speed of the inline duct fan 108 to maintain the predefined airflow. The controller 109 is configured to control the dampers 144 on the battery airflow outlet 202 and the external vent 142. The position of the dampers 144 may be based on measurements from at least one of the temperature sensors and/or at least one air flow sensors. For example, there may be an imbalance in the airflow between the battery airflow inlet 140 and the battery airflow outlet 202. The controller 109 can configure the position of the dampers to balance the airflow. If the airflow at the battery airflow inlet 140 is greater than the airflow at the battery airflow outlet 202, the controller 109 can open the dampers 144 in the external vent 142 to allow some of the excess airflow from the battery airflow inlet 140 to exhaust outside. If the airflow at the battery airflow inlet 140 is less than the airflow at the battery airflow outlet 202, the controller 109 can open the dampers 144 in the external vent 142 to allow some outside air to be drawn in and added to the airflow from the battery airflow inlet 140.

Alternatively, the position of the dampers 144 may be based on a predetermined schedule. The predetermined schedule may take into account diurnal building heating requirements, weekly building heating requirements that differentiate working days from weekends and holidays, seasonal building heating requirements, and the like. Alternatively, the position of the dampers 144 may be based both on the sensor measurements and the predetermined schedule.

The memory may include one or more memory units, including a volatile memory and a non-volatile memory. The volatile memory is based on any random-access memory (RAM) technology. For example, the volatile memory can be based on a Double Data Rate (DDR) Synchronous Dynamic Random-Access Memory (SDRAM). Other types of volatile memory 208 are contemplated.

The non-volatile memory can be based on any persistent memory technology, such as an Erasable Electronic Programmable Read Only Memory (“EEPROM”), flash memory, solid-state hard disk (SSD), other type of hard-disk, or combinations of them. The non-volatile memory may also be described as a non-transitory computer readable media. Also, more than one type of non-volatile memory may be provided.

Programming instructions in the form of applications are typically maintained, persistently, in non-volatile memory and used by the processor which reads from and writes to the volatile memory during the execution of the applications. A method can be coded as one or more applications to control the apparatus 100 described above.

As shown in FIG. 1 to FIG. 3, the thermal battery is installed on the roof 112 of the building 110 to reduce the distance between the panel 104 and the thermal battery 102 and to utilize available space provided by the flat-roof. However, the thermal battery 102 may be installed elsewhere inside or outside the building depending on factors such as available roof space, for example. The apparatus 100 illustrated in FIG. 1 to FIG. 3 can provide airflow to the ASHP 150 at a consistent temperature range throughout the year. The temperature consistency allows the ASHP 150 to operate at a suitable Coefficient of Performance (COP) throughout the year as further discussed below.

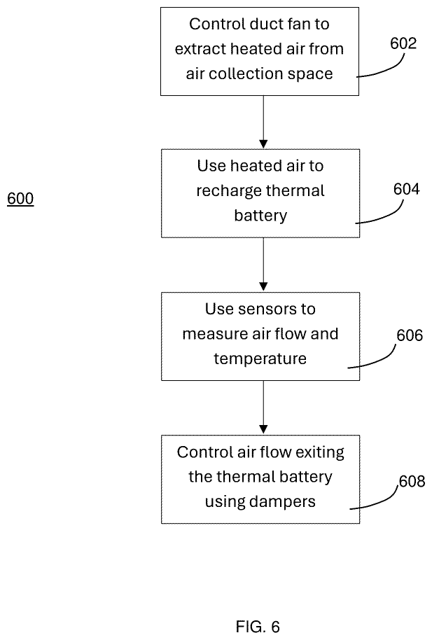

Referring to FIG. 6, operation of the apparatus 100 when mounted to the building 110 is illustrated generally by numeral 600. The controller 109 operates 602 the inline duct fan 108 to extract air from the air collection space 134 at a predefined flow rate. As a result, ambient air is drawn into the air collection space 134 between the panel 104 and the wall 114 through the inlet openings 130. As the air rises through the air collection space 134 it is heated by the panel 104. The air may also be heated by any heat loss from the wall 114. In some embodiments, exhaust from the exhaust vents 116 is also exhausted into the air collection space 134. The exhaust from the exhaust vents 116 will be warmer than the ambient air, which helps to increase the air temperature at the panel air outlet 132.

Air from the panel air outlet 132 is drawn through the duct 106 by the inline duct fan 108 and fed to the battery airflow inlet 140. The air fed into the battery airflow inlet 140 can be used to “recharge” 604 the thermal material of the thermal battery 102. The air can then be vented from the thermal battery 102 through the external vent 142 and/or communicated to the ASHP 150 through the battery airflow outlet 202. The controller 109 uses the sensors 160 to measure the airflow into and/or out of the thermal battery 102 and/or into the ASHP 150. The controller 109 also uses the sensors 160 to measure 606 the temperature of the airflow into the ASHP 150 and/or the thermal battery 102. In response to the measured airflow and temperature, the controller 109 controls 608 the air flow out of the thermal battery 102 by adjusting the dampers 144 on the external vent 142 and the battery airflow outlet 202. Thus, the controller 109 can control how much of the air flow is communicated into the ASHP 150 through the battery airflow outlet 202 and how much is vented outside or draw in through the external vent 142.

For example, during the day the panel 104 uses solar energy to heat the air in the air collection space 134. The heated air is delivered to the thermal battery 102. The heated air is used to both recharge the thermal storage material of the thermal battery 102 and act as a source for the ASHP 150. In addition to balancing the airflow, as described above, the controller 109 may determine that the ASHP 150 requires an increase in air temperature at its input due to heat required in the building. Accordingly, the damper 144 of the battery airflow outlet 202 can be adjusted to increase airflow therethrough. The damper 144 of the external vent 142 can also be adjusted to decrease airflow therethrough. Conversely, the controller 109 may determine that the ASHP 150 does not require heating in the building or an increase in air temperature at its input. Accordingly, the damper 144 of the battery airflow outlet 202 can be adjusted to decrease airflow. The damper 144 of the external vent 142 can be adjusted to increase airflow accordingly. This allows the air heated by the panel 104 to continue to recharge the thermal battery 102.

During the night, or other time when the panel 104 is insufficiently exposed to sunlight, the thermal storage material of the thermal battery 102 emits sufficient heat to increase the air temperature of the airflow emitted through the battery airflow outlet 202 to a constant temperature of approximately 10° C., for example. Such a temperature will enable the ASHP to consistently operate at a COP of about 3.

As noted above, in some embodiments, the air received at the thermal battery 102 from the panel 104 includes exhaust vented from within the building 110. Thus, in these embodiments, the air temperature emitted though the panel air outlet 132 will likely be higher than the outside air, even when the solar operation of the panel 104 is less than optimal. Further, as the exhaust can be vented through the external vent 142 after charging the thermal battery 102, the heat of the exhaust can be utilized without needing an additional heat exchanger, improving the heat efficiency of the apparatus.

A system for heating the building 110 using the apparatus 100 is described as follows. The ASHP 105 includes a heat pump fan in fluid communication with the thermal battery 102 for directing heated air through an evaporator of the ASHP 150. The ASHP 150 thereby collects heat from the heated air and transfers the collected heat to hot water at a condenser. The water is heated to a temperature between about 70° C. to about 80° C., for example, for use in the building. The ASHP 150 may be configured to use a refrigerant that does minimal harm to the environment such as an inert gas like CO₂ so that the building's heating system is compliant with environmental and hazard standards and regulations. Alternatively, the ASHP 150 may be configured to operate with a different refrigerant, such as a refrigerant that has a 20-year global warming potential of less than 530 times CO₂, for example.

Another system for heating the building 110 using the apparatus described above is described as follows. Similar to the system discussed above, the ASHP 150 includes a heat pump fan in fluid communication with the thermal battery 102 for directing heated air through an evaporator of the ASHP 150. The ASHP 150 thereby collects heat from the heated air and transfers the collected heat to hot water at a condenser of the ASHP. The hot water is stored in a liquid thermal storage tank at about 75° C., for example. A second-stage water heat pump is configured to boost the temperature of the stored hot water (for example, about 90° C.) and a steam temperature (for example, about 120° C.) for use in the building. Accordingly, it will be appreciated that the apparatus 100 described herein provides a reliable and relatively inexpensive source for the ASHP 150.

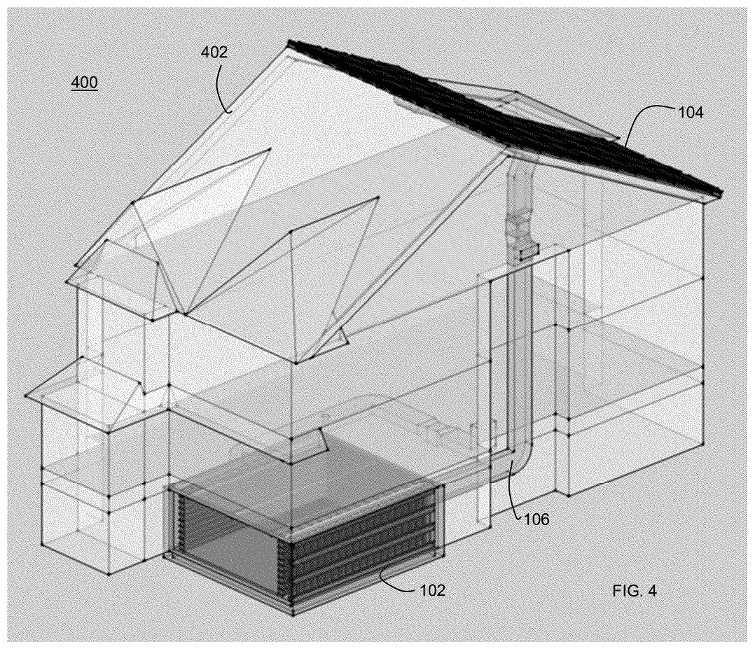

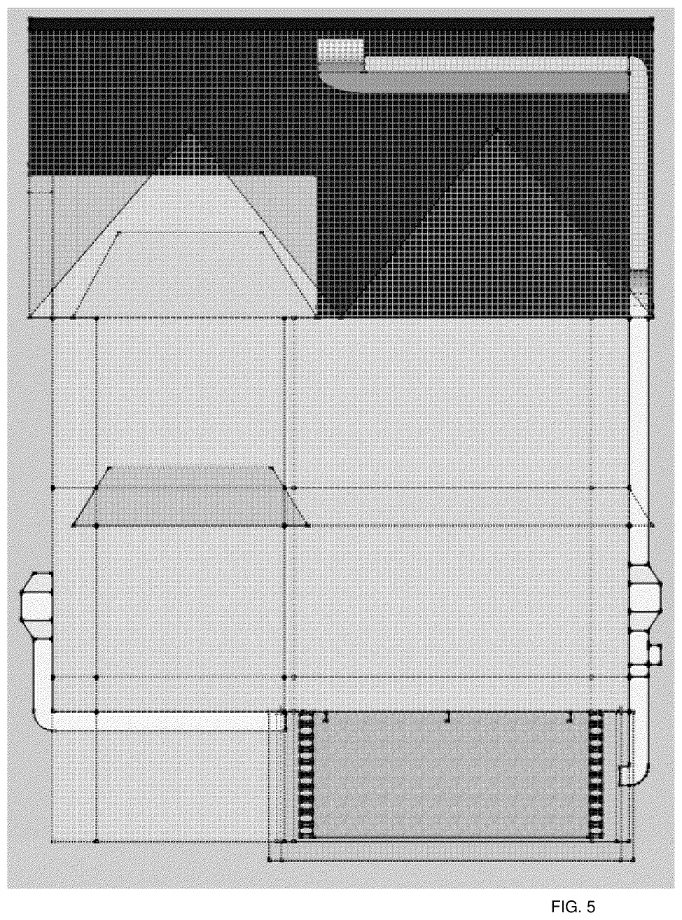

Referring to FIG. 4, a schematic drawing of an alternative embodiment is illustrated generally by reference numeral 400. In the illustrated embodiment, the building 110 has a sloped roof 402. In some embodiments, the least one sunlight-absorbent collector panel 104 is mounted on one or more sides of the sloped roof 402. The thermal battery 102 is installed in a basement 404 of the building 110. To accommodate this arrangement, the duct 106 is provided from the roof 402 of the building 110 to the basement 404 to direct the collected air from the panel 104 to the thermal battery 102. FIG. 5 depicts a top plan schematic drawing of the basement of the building of FIG. 4.

An apparatus consisting at least of a sunlight-absorbent collector panel and a thermal battery as described above can be included in a kit for retrofitting an existing building to operate an ASHP efficiently through winter. The kit may further include the ASHP, and optionally, a second-stage water heat pump to retrofit an existing building with a conventional heating system that does not already include an ASHP.

The present invention has been described by way of examples. Modifications and variations to the above-described examples are possible and may occur to those skilled in the art. All such modifications and variations are believed to be within the scope of the present invention, as defined by the claims.

For example, although the thermal battery 102 is shown as being outside of the mechanical penthouse, it may be located inside. The duct 106 may be thermally insulated. Although the application makes specific reference to the inline duct fan 108 for maintaining airflow, other air movers may also be used. In some embodiments, the fan 108 is located in the thermal battery 102, rather than in the duct 106. In some embodiments, the fan 108 is located in both the thermal battery 102 and the duct 106. In some embodiments, if air temp from panel 104 is below a threshold temperature, the 108 inline duct fan can slow down or shut off to preserve power.

Those skilled in the art will appreciate that in some embodiments, the functionality of the processor may be implemented using pre-programmed hardware or firmware elements (e.g., application specific integrated circuits (ASICs), electrically erasable programmable read-only memories (EEPROMs), etc.), or other related components.

Various terms are used to refer to particular system components. A particular component may be referred to commercially or otherwise by different names. Further, a particular component (or the same or similar component) may be referred to commercially or otherwise by different names. Consistent with this, nothing in the present disclosure shall be deemed to distinguish between components that differ only in name but not in function. In the following discussion and in the claims, the terms “including” and “comprising” are used in an open-ended fashion, and thus should be interpreted to mean “including, but not limited to . . .” Also, the term “couple” or “couples” is intended to mean either an indirect or direct connection. Thus, if a first device couples to a second device, that connection may be through a direct connection, or through an indirect connection via other devices and connections.

Further, the terminology used herein is for the purpose of describing particular example implementations only, and is not intended to be limiting. As used herein, the singular forms “a,” “an,” and “the” may be intended to include the plural forms as well, unless the context clearly indicates otherwise. The terms “a,” “an,” “the,” and “said” as used herein in connection with any type of processing component configured to perform various functions may refer to one processing component configured to perform each and every function, or a plurality of processing components collectively configured to perform each of the various functions. By way of example, “A processor” configured to perform actions A, B, and C may refer to one processor configured to perform actions A, B, and C. In addition, “A processor” configured to perform actions A, B, and C may also refer to a first processor configured to perform actions A and B, and a second processor configured to perform action C. Further, “A processor” configured to perform actions A, B, and C may also refer to a first processor configured to perform action A, a second processor configured to perform action B, and a third processor configured to perform action C. The method steps, processes, and operations described herein are not to be construed as necessarily requiring their performance in the particular order discussed or illustrated, unless specifically identified as an order of performance. It is also to be understood that additional or alternative steps may be employed.

The terms first, second, third, etc. may be used herein to describe various elements, components, regions, layers and/or sections; however, these elements, components, regions, layers and/or sections should not be limited by these terms. These terms may be only used to distinguish one element, component, region, layer, or section from another region, layer, or section. Terms such as “first,” “second,” and other numerical terms, when used herein, do not imply a sequence or order unless clearly indicated by the context. Thus, a first element, component, region, layer, or section discussed below could be termed a second element, component, region, layer, or section without departing from the teachings of the example implementations. The phrase “at least one of,” when used with a list of items, means that different combinations of one or more of the listed items may be used, and only one item in the list may be needed. For example, “at least one of: A, B, and C” includes any of the following combinations: A; B; C; A and B; A and C; B and C; and A and B and C. In another example, the phrase “one or more” when used with a list of items means there may be one item or any suitable number of items exceeding one.

Spatially relative terms, such as “inner,” “outer,” “beneath,” “below,” “lower,” “above,” “upper,” “top”, “bottom,” and the like, may be used herein for ease of description to describe one element's or feature's relationship to another element(s) or feature(s) as illustrated in the figures. For convenience, the relative terms used in the application relate to a user holding a crossbow facing forward as a reference frame. However, spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

This written description uses examples to disclose the embodiments, including the best mode, and also to enable those of ordinary skill in the art to make and use the invention. The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function.

Benefits, other advantages, and solutions to problems have been described above with regard to specific embodiments. However, the benefits, advantages, solutions to problems, and any feature(s) that can cause any benefit, advantage, or solution to occur or become more pronounced are not to be construed as a critical, required, sacrosanct or an essential feature of any or all the claims.

After reading the specification, skilled artisans will appreciate that certain features which are, for clarity, described herein in the context of separate embodiments, can also be provided in combination in a single embodiment. Conversely, various features that are, for brevity, described in the context of a single embodiment, can also be provided separately or in any sub-combination. Further, references to values stated in ranges include each and every value within that range.

The scope of the claims should not be limited by the embodiments set forth in the above examples, but should be given the broadest interpretation consistent with the description as a whole.

1. An apparatus for outputting heated air when mounted to a building, the apparatus comprising:
at least one sunlight-absorbent collector panel configured to heat air passing proximal thereto, the panel shaped to create an enclosed air collection space when mounted to the building,
wherein the air collection space is configured to collect exhaust from exhaust vents in the building when the panel is coupled to the building, the exhaust being warmer than the ambient air, the panel comprising:
a plurality of inlet openings; and
a panel outlet;
a thermal battery comprising:
thermal material;
a battery airflow inlet;
an external vent configured to interface with the ambient air outside the battery;
a battery airflow outlet configured to be in fluid communication with an air-to-water air-source heat pump (ASHP); and
one or more dampers configured to control the airflow rate through the external vent and/or the battery airflow outlet;
an air mover configured to maintain a predefined airflow from the panel outlet to the battery airflow inlet; and
a controller configured to control the position of the one or more dampers.

2. The apparatus of claim 1 further comprising a plurality of sensors configured to detect a temperature of airflow from the battery airflow outlet and/or and an airflow speed from the panel outlet; wherein the controller is configured to control the position of the one or more dampers in response to the detected temperature and/or and airflow speed.

3. The apparatus of claim 2 further comprising a duct configured to couple the panel outlet with the battery airflow inlet.

4. The apparatus of claim 1, wherein the inlet openings in the panel are located along a surface of the panel.

5. The apparatus of claim 1, wherein the thermal material is a phase change material (PCM) having a melting point configured to provide a predefined air temperature for the ASHP.

6. The apparatus of claim 5, wherein the predefined air temperature is in a range of 5° C. to 15° C.

7. The apparatus of claim 3, wherein the air mover is an inline fan positioned with the duct and/or a fan positioned within the thermal battery.

8. The apparatus of claim 1, wherein the battery airflow outlet comprises an opening configured to couple the thermal battery to a mechanical penthouse room of the building.

9. (canceled)

10. A system for heating a building the system comprising:
at least one sunlight-absorbent collector panel coupled to the building, the panel configured to heat air passing proximal thereto, the panel shaped to create an enclosed air collection space between the building and the panel,
wherein the air collection space is configured to collect exhaust from exhaust vents in the building, the exhaust being warmer than the ambient air, the panel comprising:
a plurality of inlet openings; and
a panel outlet;
a thermal battery comprising:
thermal material;
a battery airflow inlet;
an external vent configured to interface with the ambient air outside the battery;
a battery airflow outlet; and
one or more dampers configured to control the airflow rate through the external vent and/or the battery airflow outlet;
an air mover configured to maintain a predefined airflow from the panel outlet to the battery airflow inlet;
a controller configured to control the position of the one or more dampers; and
an air-to-water air-source heat pump (ASHP) in fluid communication with the battery airflow outlet, the ASHP configured to collect heat from the air received from the thermal battery and transfer the collected heat to hot water.

11. The system of claim 10 further comprising a plurality of sensors configured to detect a temperature of airflow from the battery airflow outlet and/or an airflow speed from the panel outlet; wherein the controller is configured to control the position of the one or more dampers in response to the detected temperature and/or airflow speed.

12. The system of claim 10 further comprising a duct configured to couple the panel outlet with the battery airflow inlet.

13. The system of claim 10, wherein the inlet openings in the panel are located along a surface of the panel.

14. The system of claim 10, wherein the thermal material is a phase change material (PCM) having a melting point configured to provide a predefined air temperature for the ASHP.

15. (canceled)

16. The system of claim 10 further comprising a second-stage water heat pump configured to boost a temperature of the hot water from the ASHP to one of a higher water temperature and a steam temperature for use in heating the building.

17. The system of claim 12, wherein the air mover is an inline fan positioned with the duct.

18. The system of claim 10, wherein the battery airflow outlet comprises an opening configured to couple the thermal battery to a mechanical penthouse room of the building.

19. A method for controlling airflow at the thermal battery of the apparatus of claim 1, the method comprising:
using sensors to measure an input airflow at the battery airflow inlet, the input airflow heated by the at least one sunlight-absorbent collector panel and the collected exhaust;
using sensors to measure an output airflow at the battery airflow outlet for output to the ASHP; and
controlling the one or more dampers in the external vent and/or the battery airflow outlet to balance the input airflow and the output airflow.

20. The method of claim 19, wherein when the input airflow is greater than the output airflow, the damper is controlled to allow excess airflow from input airflow exhaust to the outside.

21. The method of claim 19, wherein when the input airflow is less than the output airflow, the damper is controlled to allow air to be drawn in from the outside to combine with the input airflow.
